(19) United States
(12) Patent Application Publication
(10) Pub. No.: US 2006/0032037 A1
(43) Pub. Date: Feb. 16, 2006

(54) [ASSEMBLING METHOD AND DEVICE THEREOF]

(76) Inventors: Dar-Wen Lo, Keelung City (TW); Chang-An Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,930

(22) Filed: Aug. 13, 2004

(51) Int. Cl. B23Q 3/00

(52) U.S. Cl. 29/464; 29/281.1; 269/21; 29/465

(57) ABSTRACT

An assembling device and method for mounting a second plate to a first plate is described. The assembling device is an alignment jig includes a first carrier plate having a first air channel and a first carrier area and a second carrier plate having a second air channel and a second carrier area. The first air channel is linked to the first carrier area and the first plate is on the first carrier area. The second carrier plate and the first carrier plate are joined together through a pivot and the second carrier plate is stacked over the first carrier plate. The second air channel is linked to the second carrier area. The second plate is over the second carrier area. The second carrier plate or the first carrier plate has a third air channel and the corresponding second or third plate has an opening exposing the third air channel.

### BACKGROUND OF INVENTION

1. Field of the Invention

The present invention relates to an assembling method and a device thereof. More particularly, the present invention relates to an assembling method and a device for alignment assembly under vacuum environment.

2. Description of Related Art

With the maturity of semiconductor fabrication techniques, various types of sensors are installed inside all kinds of electronic products. For digital cameras or mobile phones with photographic functions, image sensors are one of the critical factors indicating the quality of the products. In general, image sensors are grouped into charge-coupled device (CCD) sensors or complementary metal-oxide-semiconductor (CMOS) image sensors. Both the CCD sensors and the CMOS image sensors have a photodiode array located within a photosensitive area. The photodiode array is capable of receiving image signals (or light intensity variation signals) and transforming the image signals into electrical signals through an analogue/digital converter for image processing or regrouping.

FIG. 1 is a schematic cross-sectional view of a conventional image sensor. As shown in FIG. 1, a conventional image sensor 100 comprises a chip 110, a glass plate 120 and a plastic frame 130. The plastic frame 130 is set up between the chip 110 and the glass plate 120. The chip 110, the glass plate 120 and the plastic frame 130 together constitute a space 100a. The chip 110 is a CMOS image sensor chip, for example, capable of receiving an incident light beam passing through the glass plate 120 and outputting electrical signals. It should be noted that the glass plate 120 and the plastic frame 130 assembly is an effective barrier against the infiltration of dust particles or moisture into the chip 100 leading to chip 110 failure.

The process of fabricating the image sensor 100 in FIG. 1 includes the following steps. First, a wafer (not shown) having a plurality of chips 110 thereon is provided. Next, a plastic frame 130 is bonded to the peripheral region of each chip 110 on the wafer. Thereafter, a glass plate 120 is attached to the upper surface of the plastic frame 130. The wafer, the glass plate 120 and the plastic frame 130 are cured before cutting the wafer to obtain a plurality of individual image sensors 100.

It should be noted that the process of disposing the glass plates 120 over the plastic frames 130 is carried out in a normal atmosphere. Hence, if an air vent is not provided somewhere in the plastic frame 130, the plastic frame 130 may crack due to air impact. Furthermore, because the assembling process is carried out in a normal atmospheric environment, the space 100a inside the image sensor is subjected to an atmospheric pressure after the package is sealed. When the image sensor 100 undergoes a reliability analysis such as a temperature cycling test (TCT), the heating process may lead to an expansion of the trapped air inside the space 100a. The expansion of gases inside the space 100 may fracture or weaken the plastic frame 130. Ultimately, dust particles and moisture can diffuse into the interior to damage the chip 110.

### SUMMARY OF INVENTION

Accordingly, the present invention is directed to an assembling device for providing a vacuum assembling environment to reduce the amount of air within a sealed device.

In addition, the present invention is directed to an assembling device for providing an alignment assembly to enhance the reliability.

Moreover, the present invention is directed to an assembling method for providing a vacuum assembling environment to reduce the amount of air within a sealed device.

Furthermore, the present invention is directed to an assembling method for providing an alignment assembly to enhance the reliability.

In accordance with an embodiment of the present invention, an assembling device is provided for mounting a second plate to a first plate. The assembling device is an alignment jig having a first carrier plate and a second carrier plate. The first carrier plate has a first air channel, a plurality of first openings and a first carrier area. The first openings are disposed on the first carrier area and linked to the first air channel. The first plate is disposed on the first carrier area covering the first openings. The second carrier plate and the first carrier plate are joined together through a pivot and the second carrier plate is stacked over the first carrier plate. The second carrier plate has a second air channel, a plurality of second openings and a second carrier area. The second openings are disposed on the second carrier area and linked to the second air channel. The second plate is disposed over the second carrier area covering the second openings. The second carrier plate or the first carrier plate has a third air channel and at least a third opening linked to the third air channel and the corresponding second plate or third plate exposes the third opening.

According to one embodiment of the present invention, the first carrier plate further comprises a plurality of first concentric circular grooves disposed on the first carrier area. The first openings are disposed inside these first concentric circular grooves.

According to one embodiment of the present invention, the second carrier plate further comprises a plurality of second concentric circular grooves disposed on the second carrier area. The second openings are disposed inside these second concentric circular grooves.

According to one embodiment of the present invention, the first carrier plate further comprises a plurality of first positioning pins disposed on the first carrier area.

According to one embodiment of the present invention, the second carrier plate further comprises a plurality of second positioning pins disposed on the second carrier area.

According to one embodiment of the present invention, the first carrier plate further comprises a sealing ring disposed on the peripheral region of the first carrier area.

According to one embodiment of the present invention, the first carrier plate is fabricated using metal or plastics, for example.

According to one embodiment of the present invention, the second carrier plate is fabricated using metal or plastics, for example.

The present invention is also directed to an alternative assembling device for mounting a second plate to a first plate. The assembling device is an alignment jig having a first carrier plate and a second carrier plate. The first plate is disposed on the first carrier area. The second carrier plate and the first carrier plate are joined together through a pivot and the second carrier plate is stacked over the first carrier plate. The second carrier plate has a second air channel, a plurality of second openings and a second carrier area. The second openings are disposed on the second carrier area and linked to the second air channel. The second plate is disposed over the second carrier area covering the second openings. The second carrier plate or the first carrier plate has a third air channel and at least a third opening linked to the third air channel and the corresponding second plate or third plate exposes the third opening.

According to one embodiment of the present invention, the second carrier plate further comprises a plurality of second concentric circular grooves disposed on the second carrier area. The second openings are disposed inside these second concentric circular grooves.

According to one embodiment of the present invention, the first carrier plate further comprises a plurality of first positioning pins disposed on the first carrier area.

According to one embodiment of the present invention, the second carrier plate further comprises a plurality of second positioning pins disposed on the second carrier area.

According to one embodiment of the present invention, the first carrier plate further comprises a sealing ring disposed on the peripheral region of the first carrier area.

According to one embodiment of the present invention, the first carrier plate is fabricated using metal or plastics, for example.

According to one embodiment of the present invention, the second carrier plate is fabricated using metal or plastics, for example.

The present invention is also directed to a high-vacuum alignment jig assembly at least comprising an air-evacuating device and a sealed chamber. The air-evacuating device is connected to the sealed chamber. The sealed chamber comprises a first carrier plate, a second carrier plate and a sealing ring. The sealing ring seals the space within the first and the second carrier plate when the air within the chamber enclosed by the first and the second carrier plate is evacuated to produce a high vacuum. A pair of plates can be aligned and assembled within the sealed chamber so that the air pressure within the space between these plates after the assembly process is smaller than the atmospheric pressure.

According to one embodiment of the present invention, the air-evacuating device comprises a vacuum pump. Furthermore, the first carrier plate has an air channel linking the vacuum pump and the sealed chamber.

According to one embodiment of the present invention, the air-evacuating device comprises a vacuum pump. Furthermore, the second carrier plate has an air channel linking the vacuum pump and the sealed chamber.

In accordance with an embodiment of the present invention, an assembling method for alignment of a plastic frame of an image sensor is provided. First, a first plate and a second plate are placed over a first carrier plate and a second carrier plate respectively. The first plate and the second plate are chucked to the first carrier plate and the second carrier plate respectively by using an air-evacuating device connected to the first carrier plate and the second carrier plate. Then, the first carrier plate is flipped over the second carrier plate to form a sealed chamber, wherein the first plat and the second plate are sealed in the sealed chamber. Next, the sealed chamber is pumped to a first pressure below a pressure outside the sealed chamber. Then, the first plate is released from the first carrier plate to fall on the second plate, wherein the first plate and the second plate are mutually adhered by a plastic frame therebetween. Next, the sealed chamber is vented to a second pressure higher than the first pressure. Thereafter, a photocuring step is performed to cure the plastic frame by illuminating a light into the sealed chamber. Then, the sealed chamber is vented to the pressure outside the sealed chamber to take out an assembly of the first plate and the second plate.

According to one embodiment of the present invention, the first pressure is lower than the pressure outside the sealed chamber in a range of about 40 kPa to about 50 kPa.

According to one embodiment of the present invention, the second pressure is lower than the pressure outside the sealed chamber in a range of about 30 kPa to about 37.5 kPa.

According to one embodiment of the present invention, the photocuring step is performed by using an ultraviolet light to illuminate the plastic frame to cure the plastic frame.

Accordingly, the assembling method and device thereof of the present invention deploys an assembly comprising a first carrier plate, a second carrier plate and a set of air channels to provide a high vacuum assembling environment. In a high vacuum assembling environment, the assembled structures can have a higher degree of reliability. Hence, when compared with expensive high vacuum equipment, the assembling device of the present invention has the advantage of structural simplicity.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional image sensor.

FIG. 2A is a perspective view of an assembling device according to a first embodiment of the present invention.

FIG. 2B is a schematic cross-sectional view of the assembling device according to the first embodiment of the present invention.

FIG. 2C is a schematic cross-sectional view illustrating an assembling method according to one embodiment of the present invention.

FIG. 3A is a perspective view of an assembling device according to a second embodiment of the present invention.

FIG. 3B is a schematic cross-sectional view of the assembling device according to the second embodiment of the present invention.

FIG. 4A is a perspective view of an assembling device according to a third embodiment of the present invention.

FIG. 4B is a schematic cross-sectional view of the assembling device according to the third embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

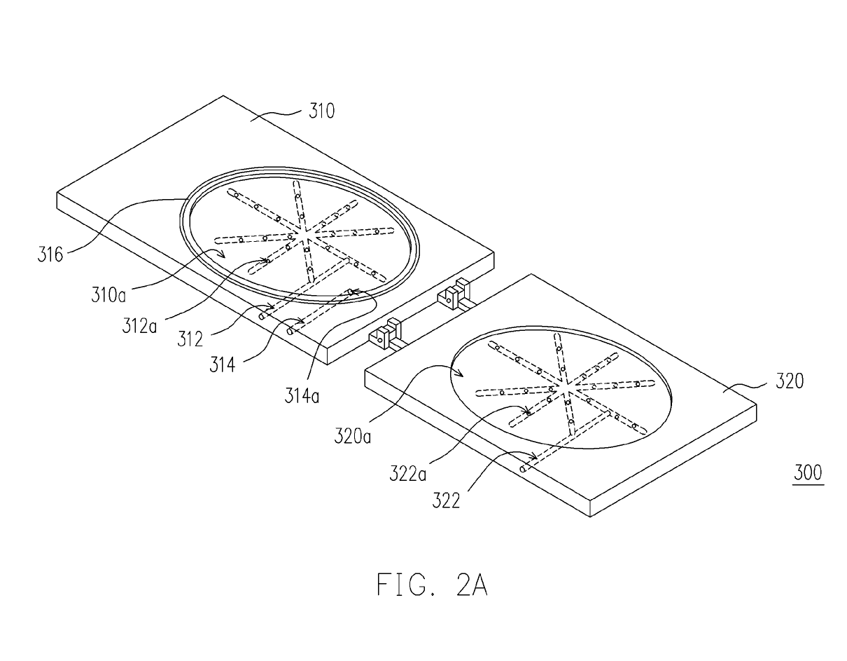

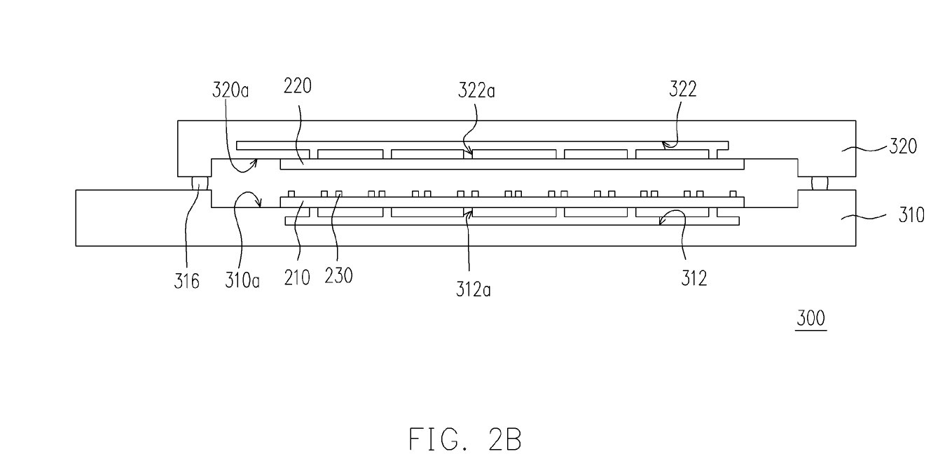

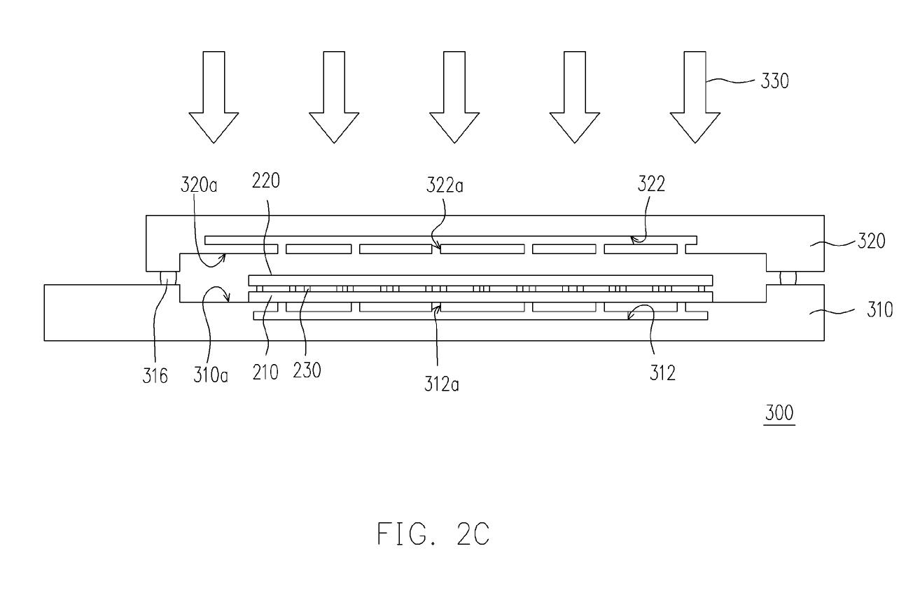

FIG. 2A is a perspective view of an assembling device according to a first embodiment of the present invention. FIG. 2B is a schematic cross-sectional view of the assembling device according to the first embodiment of the present invention. The assembling device 300 as shown in FIGS. 2A and 2B is an alignment jig suitable for assembling a second plate 220 and a first plate 210 together. The second plate 220 is a glass plate, an acrylic plate or other transparent substrate and the first plate 210 is a wafer, for example. Furthermore, a plastic frame 230 is disposed on the first plate 210 (as shown in FIG. 2B) or the second plate 220. In addition, the first plate 210, the second plate 220 and the plastic frame 230 together constitute a plurality of CMOS image sensor chips or a plurality of CCD image sensor chips. Therefore, the alignment and assembling of the CMOS image sensor chips or CCD image sensor chips can be carried out using the assembling device 300 of the present invention.

As shown in FIGS. 2A and 2B, the assembling device 300 comprises a first carrier 310 and a second carrier 320. The first carrier 310 has a first air channel 312, a plurality of first openings 312a and a first carrier area 310a. The first openings 312a are disposed on the first carrier area 310a and linked to the first air channel 312. The first plate 210 is disposed on the first carrier area 310a (as shown in FIG. 2B), covering the first openings 312a. Furthermore, the first carrier plate 310 comprises a third air channel 314 and at least a third opening 314a linked to the third air channel 314 such that the first plate 210 exposes the third opening 314a. The first carrier plate 310 also comprises a sealing ring 316 disposed on the peripheral region of the first carrier area 310a.

The second carrier plate 320 and the first carrier plate 310 are joined together by a hinge and the second carrier plate 320 is stacked on top of the first carrier plate 310 (as shown in FIG. 2B). The second carrier plate 320 has a second air channel 322, a plurality of second openings 322a and a second carrier area 320a. The second openings 322a are disposed on the second carrier area 320a and linked to the second air channel 322. The second plate 220 is disposed on the second carrier area 320a (as shown in FIG. 2B), covering the second openings 322a. Furthermore, the first carrier plate 310 and the second carrier plate 320 are fabricated using metal or plastics, for example. The plastic material includes acrylic or other hard substances, for example. In addition, if the first carrier plate 310 and the second carrier plate 320 are fabricated using metal, a combination of casting and drilling operations may be deployed to form the first air channel 312, the second air channel 322 and the third air channel. On the other hand, if the first carrier plate 310 and the second carrier plate 320 are fabricated using a plastic material, a combination of casting and drilling or injection molding and drilling operations may be deployed to form the first carrier plate 310 and the second carrier plate 320. However, the material constituting the first carrier plate 310 and the second carrier plate 320 need not be a metal or a plastic alone. The first carrier plate 310 and the second carrier plate 320 can be fabricated using a composite material including metal and plastics. Moreover, the sealing ring 316 is not limited to a position on the peripheral region of the first carrier area 310a. The sealing ring 316 may be positioned on the peripheral region of the second carrier area 320a as well.

Hereinafter, an assembling method of the present invention for alignment assembly wull be described by, for example but not limited to, using the assembling device 300 as an exemplary example. First, the assembling device 300 is opened (as shown in FIG. 2A). Next, a first plate 210 and a second plate 220 are placed on the first carrier area 310a of the first carrier plate 310 and the second carrier area 320a of the second carrier plate 320 respectively. Thereafter, a vacuum pump with pipeline (not shown) linking to the first air channel 312 and the second air channel 322 is activated to produce a partial vacuum. Hence, the first plate 210 and the second plate 220 are attached to the first carrier plate 310 and the second carrier plate 320 respectively through suction. The second carrier plate 320 is then flipped over to stack on top of the first carrier 310. Thus, the first carrier plate 310, the second carrier plate 320 and the sealing ring 316 together form a sealed chamber. The vacuum pump is also linked to the third air channel 314 through a pipeline. When the air inside the sealed chamber is pumped by the vacuum pump via the third air channel 314, the pressure inside the chamber is pumped to a first pressure below the pressure outside the sealed chamber. In one embodiment of the present invention, the first pressure is lower than the pressure outside the sealed chamber in a range of about 40 kPa to about 50 kPa.

FIG. 2C is a schematic cross-sectional view illustrating an assembling method according to one embodiment of the present invention. Thereafter, referring to FIG. 2C, the sealed chamber is vented to a second pressure higher that the first pressure via the second air channel 322. Therefore, the second plate 220 detaches from the second carrier plate 320 and then attaches to the plastic frame 230 on the first plate 210. Thus, the first plate 210, the plastic frame 230, and the second plate 220 are aligned. In one embodiment of the present invention, the second pressure is lower than the pressure outside the sealed chamber in a range of about 30 kPa to about 37.5 kPa. It is noted that, the pressure inside the plastic frame (e.g., the first pressure) is lower than the pressure of the sealed chamber (e.g., the second pressure). Therefore, the first plate 210, the plastic frame 230, and the second plate 220 are pressed by the pressure difference inside and outside the plastic frame 230, and thus the process time for assembling thereof are shorten.

Then, referring to FIG. 2C, the first plate 210, the plastic frame 230, and the second plate 220 are assembled by performing a photocuring step to cure the plastic frame 230 by illuminating a light into the sealed chamber. Then, the sealed chamber is vented to the pressure outside the sealed chamber to take out an assembly of the first plate and the second plate. In one embodiment of the present invention, the photocuring step is performed by, for example but not limited to, using an ultraviolet light to illuminate the plastic frame 230 to cure the plastic frame 230. In another embodiment of the present invention, the photocuring step may also be performed by another type of light beam.

Thereafter, the sealed chamber is vented to the pressure outside the sealed chamber to release the suction between the first carrier plate 310 and the second carrier plate 320 via the second air channel 322 and the third air channel 314. The second carrier plate 320 is flipped open so that the final product comprising the first plate 210, the second plate 220 and the plastic frame 230 can be retrieved.

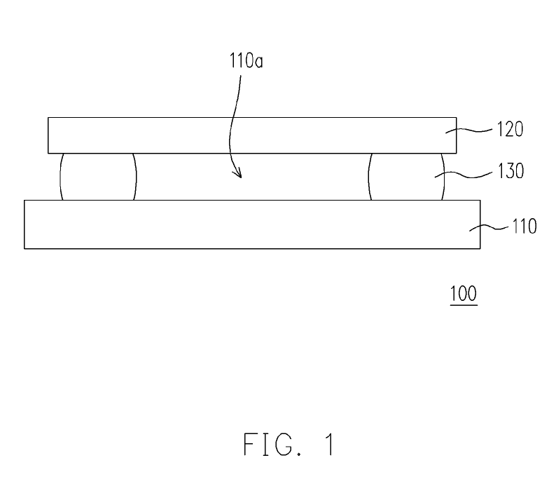

In a conventional image sensor 100 (as shown in FIG. 1), the air pressure within the enclosed space 100a is close to atmospheric pressure. As temperature rises, the air pressure inside the enclosed space 100a will expand and hence crack or damage the plastic frame 130. As shown in FIG. 2, the assembling device 300 utilizes the assembly including the first carrier plate 310, the second carrier plate 320 and the third air channel 314 to produce a sealed chamber with a high degree of vacuum. Since the first plate 210 and the second plate 220 are assembled together in a high vacuum environment, the air pressure enclosed by the first plate 210 and the second plate 220 is smaller than atmospheric. In fact, the air pressure inside the sealed chamber is preferably about 50 kpa below the atmospheric pressure. Hence, compared with a conventional image sensor 100, the first plate 210 and the second plate 220 assembled using the assembling device 300 has a better reliability. It should be noted that the third air channel 314 and the third opening 314a need not be disposed on the first carrier plate 310. The third air channel 314 and the third opening 314a may also be disposed over the second carrier plate 320. In addition, the actual position and design of the first air channel 312 and the first opening 312a, the second air channel 322 and the second opening 322a and the third air channel 314 and the third opening 314a may differ from the ones shown in the figures. Other types of designs can be used according to specific requirements.

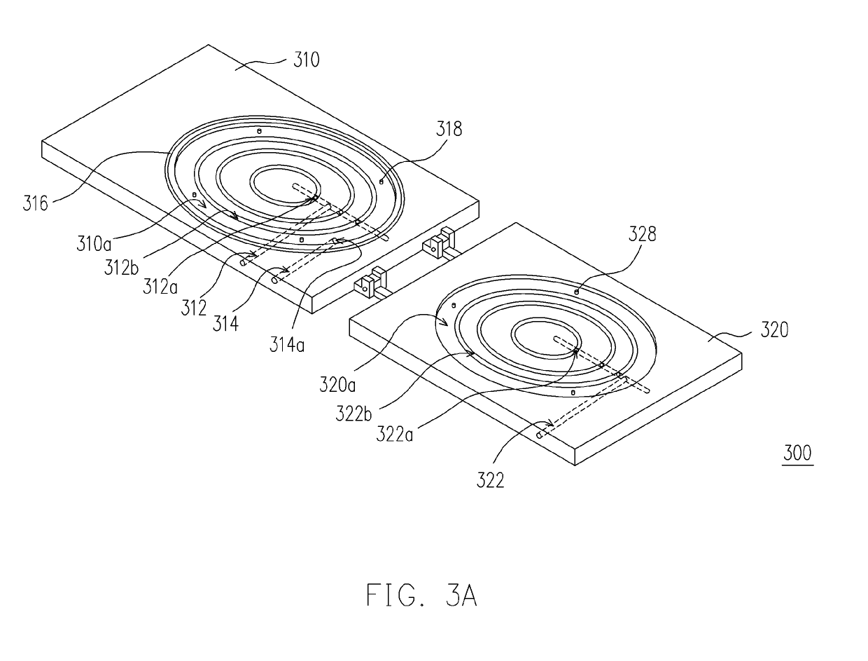

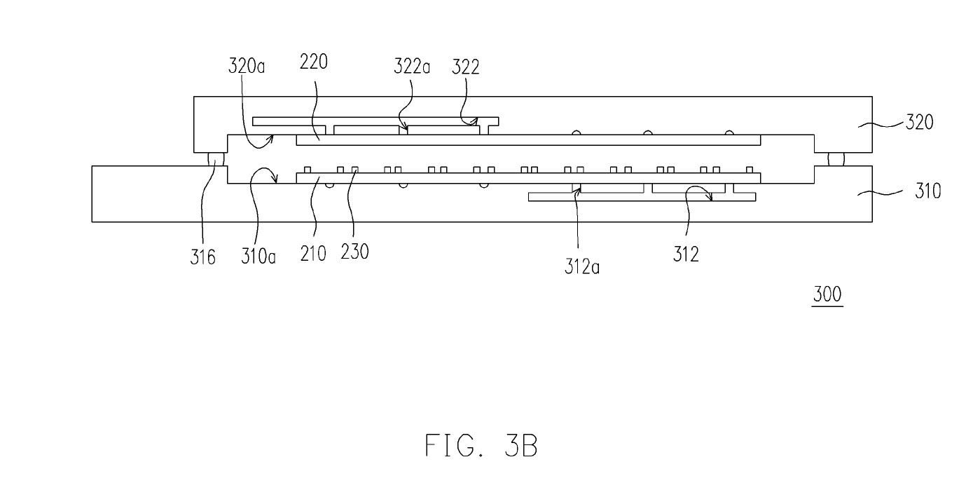

FIG. 3A is a perspective view of an assembling device according to a second embodiment of the present invention. FIG. 3B is a schematic cross-sectional view of the assembling device according to the second embodiment of the present invention. In the second embodiment, elements having an identical function to the first embodiment are labeled identically. To increase the suction of the first carrier plate 310 and the second carrier plate 320 towards the first plate 210 and the second plate 220, the first carrier plate 310 and the second carrier plate 320 may further comprise a plurality of concentric circular grooves 312b and 322b respectively. The first concentric circular grooves 312b and the second concentric circular grooves 322b are disposed on the first carrier area 310a and the second carrier area 320a respectively. Furthermore, the first openings 312a and the second openings 322a are located inside the first concentric circular grooves 312b and the second concentric circular grooves 322b. Hence, the contact area between the first plate 210 and the first air channel 312 as well as between the second plate 220 and the second air channel 322 is increased. Ultimately, the first carrier plate 310 and the second carrier plate 320 have a greater capacity for holding the first and second plates 210 and 220.

It should be noted that the grooves on the first carrier plate 310 and the second carrier plate 320 need not be concentric circular grooves. Grooves having some other shape or profile can also be used. Furthermore, it is unnecessary for the first carrier plate 310 and the second carrier plate 320 to have the same concentric circular groove pattern. Various combinations of groove patterns may be used. In addition, the first concentric circular grooves 312b and the second concentric circular grooves 322b can be fabricated, for example, by milling using a milling machine. The first air channel 312, the second air channel 322 and the third air channel 314 can be fabricated, for example, by casting and drilling.

To facilitate the positioning of the first plate 210 and the second plate 220 on the first carrier plate 310 and the second carrier plate 320, the first carrier plate 310 may further comprise a plurality of first positioning pins 318 disposed on the first carrier area 310a and the second carrier plate 320 may further comprise a plurality of second positioning pins 328 disposed on the second carrier area 320a. Through the first positioning pins 318 and the second positioning pins 328, an operator can quickly orient the first plate 210 and the second plate 220 relative to the first carrier area 310a and the second carrier area 320a respectively.

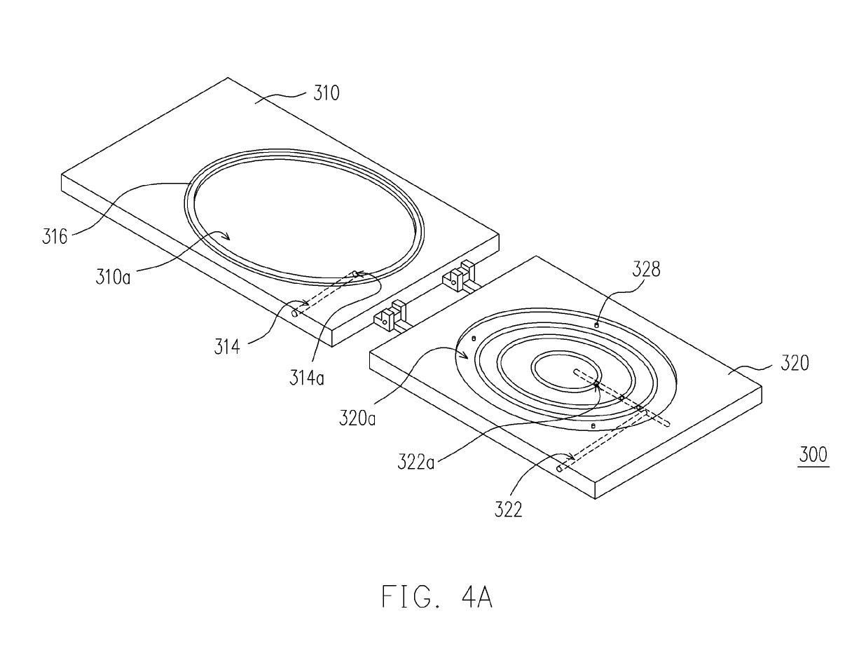

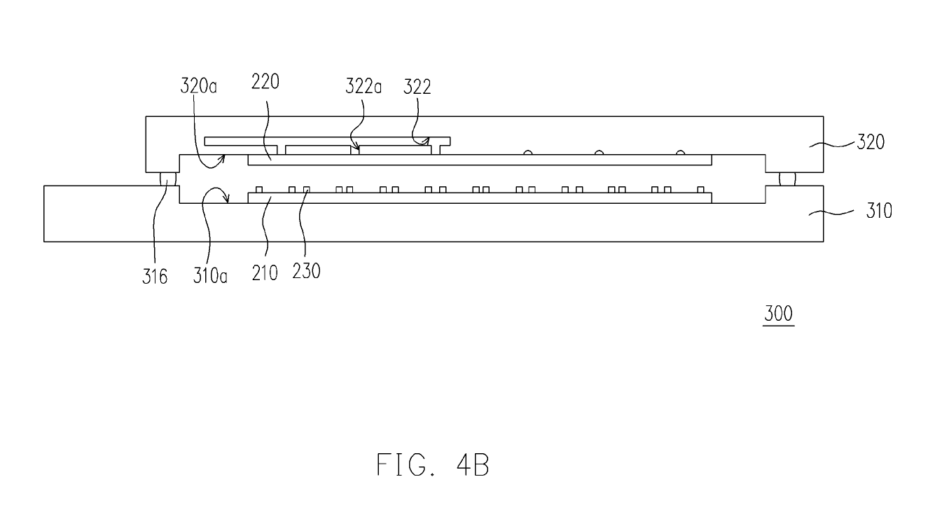

FIG. 4A is a perspective view of an assembling device according to a third embodiment of the present invention. FIG. 4B is a schematic cross-sectional view of the assembling device according to the third embodiment of the present invention. In the third embodiment, elements having an identical function to the second embodiment are labeled identically. In the first and the second embodiments of the present invention, the assembling device 300 utilizes the negative air pressure due to the withdrawal of air from first air channel 312 to suck up and bind the first plate 210 to the first carrier plate 310. It should be noted that there is no need to flip or move the first plate 210 throughout the assembling process. In other words, the first air channel 312 and the first opening 312a in the first carrier plate 310 in the first embodiment are non-essential. Similarly, in the second embodiment, the first air channel 312, the first opening 312a and the first concentric circular grooves 312b in the first carrier plate 310 is non-essential.

In the first, the second and the third embodiments, the first plate 210 and the second plate 220 are assembled together with the surrounding pressure smaller than atmospheric pressure. Therefore, the assembled structure is more capable of withstanding the pressure variation caused by an increase in temperature. It should be noted that the assembling process of the first plate 210 and the second plate 220 could be carried out inside a vacuum chamber with the manipulation of a robotic arm. However, vacuum equipment is generally expensive and costly to maintain. The assembling device 300 of the present invention is able to create a vacuum assembling environment through the third air channel 314 together with an inexpensive air withdrawing device.

In summary, some the advantages of the assembling method and device thereof according to the present invention is described. First, the present invention is able to create a high vacuum environment for assembling utilizing a third air channel linked to an air-withdrawing device. In addition, the high vacuum environment created inside the assembling method and device thereof is able to produce an assembled structure with a better reliability than the conventional assembling technique. Moreover, compared with vacuum equipment, the assembling device has a simple structure and inexpensive to fabricate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An assembling device for mounting a second plate on a first plate, comprising:
a first carrier plate, having a first air channel, a plurality of first openings, and a first carrier area, wherein the first openings are disposed on the first carrier area and linked to the first air channel, and the first plate covering the first openings is disposed on the first carrier area; and
a second carrier plate, having a second air channel, a plurality of second openings, and a second carrier area, wherein the second carrier plate is pivoted to the first carrier plate and stacked over the first carrier plate, the second openings are disposed on the second carrier area and linked to the second air channel, the second plate covering the second openings is disposed on the second carrier area, and the second carrier plate or the first carrier plate has a third air channel and at least a third opening linked to the third air channel such that the corresponding second plate or first plate exposes the third opening.

2. The assembling device of claim 1, wherein the first carrier plate further comprises a plurality of first concentric circular grooves disposed on the first carrier area with the first openings disposed inside the first concentric circular grooves.

3. The assembling device of claim 1, wherein the second carrier plate further comprises a plurality of second concentric circular grooves disposed on the second carrier area with the second openings disposed inside the second concentric circular grooves.

4. The assembling device of claim 1, wherein the first carrier plate further comprises a plurality of first positioning pins disposed on the first carrier area.

5. The assembling device of claim 1, wherein the second carrier plate further comprises a plurality of second positioning pins disposed on the second carrier area.

6. The assembling device of claim 1, wherein the first carrier plate further comprises a sealing ring disposed on the peripheral region of the first carrier area.

7. The assembling device of claim 1, wherein material constituting the first carrier plate is selected from a group consisting of metals and plastics.

8. The assembling device of claim 1, wherein material constituting the second carrier plate is selected from a group consisting of metals and plastics.

9. An assembling device for mounting a second plate on a first plate, comprising:
a first carrier plate having a first carrier area, wherein the first plate is disposed on the first carrier area; and
a second carrier plate having a second air channel, a plurality of second openings, and a second carrier area, wherein the second carrier plate is pivoted to the first carrier plate and stacked over the first carrier plate, the second openings are disposed on the second carrier area and linked to the second air channel, the second plate covering the second openings is disposed on the second carrier area, and the second carrier plate or the first carrier plate has a third air channel and at least a third opening linked to the third air channel such that the corresponding second plate or first plate exposes the third opening.

10. The assembling device of claim 9, wherein the second carrier plate further comprises a plurality of second concentric circular grooves disposed on the second carrier area with the second openings disposed inside the second concentric circular grooves.

11. The assembling device of claim 9, wherein the first carrier plate further comprises a plurality of first positioning pins disposed on the first carrier area.

12. The assembling device of claim 9, wherein the second carrier plate further comprises a plurality of second positioning pins disposed on the second carrier area.

13. The assembling device of claim 9, wherein the first carrier plate further comprises a sealing ring disposed on the peripheral region of the first carrier area.

14. The assembling device of claim 9, wherein material constituting the first carrier plate is selected from a group consisting of metals and plastics.

15. The assembling device of claim 9, wherein material constituting the second carrier plate is selected from a group consisting of metals and plastics.

16. An alignment jig for vacuum assembly, comprising:
an air-evacuating device; and
a sealed chamber connected to the air-evacuating device, wherein the sealed chamber comprising a first carrier plate, a second carrier plate, and a sealing ring, the first and the second carrier plate produces a sealed space through the sealing ring after evacuating the air inside, and the sealed chamber is suitable for assembling a pair of plates together at a pressure below the atmospheric.

17. The alignment jig of claim 16, wherein the air-evacuating device comprises a vacuum pump and the first carrier plate has a corresponding air channel linking the vacuum pump and the sealed chamber.

18. The alignment jig of claim 16, wherein the air-evacuating device comprises a vacuum pump and the second carrier plate has a corresponding air channel linking the vacuum pump and the sealed chamber.

19. An assembling method, comprising:
placing a first plate and a second plate over a first carrier plate and a second carrier plate respectively, wherein the first plate and the second plate are chucked to the first carrier plate and the second carrier plate respectively by using an air-evacuating device connected to the first carrier plate and the second carrier plate;
flipping the first carrier plate over the second carrier plate to form a sealed chamber, wherein the first plat and the second plate are sealed in the sealed chamber;
pumping the sealed chamber to a first pressure below a pressure outside the sealed chamber;
releasing the first plate from the first carrier plate to fall on the second plate, wherein the first plate and the second plate are mutually adhered by a plastic frame therebetween;
venting the sealed chamber to a second pressure higher than the first pressure;
performing a photocuring step to cure the plastic frame by illuminating a light into the sealed chamber; and
venting the sealed chamber to the pressure outside the sealed chamber to take out an assembly of the first plate and the second plate.

20. The aligned assembly method of claim 1, wherein the first pressure is lower than the pressure outside the sealed chamber in a range of about 40 kPa to about 50 kPa.

21. The aligned assembly method of claim 1, wherein the second pressure is lower than the pressure outside the sealed chamber in a range of about 30 kPa to about 37.5 kPa.

22. The aligned assembly method of claim 1, wherein the photocuring step is performed by using an ultraviolet light to illuminate the plastic frame to cure the plastic frame.
